(19) United States
(12) Patent Application Publication
(10) Pub. No.: US 2006/0268235 A1
(43) Pub. Date: Nov. 30, 2006

(54) Projection lens, optical projection apparatus and method for reducing distortion utilizing the same

(75) Inventors: Cheng Kuang Lee, Taipei County (TW); Jung Yao Chen, Taoyuan County (TW); Chih Yuan Wang, Taoyuan County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/437,346

(22) Filed: May 19, 2006

(30) Foreign Application Priority Data
May 31, 2005 (TW) TW94117794

(51) Int. Cl. G03B 21/26

(52) U.S. Cl. 353/30

(57) ABSTRACT

An apparatus for reducing projection distortion is provided. The apparatus comprises a projection lens fitting a specific distortion curve. The projection lens, comprises at least one lens, the distortion curve specifies relationships between distortion rates and projection optical fields of the projection lens, and a first distortion rate difference within a projection optical field range on the distortion curve is less than a second distortion rate difference within the projection optical field range on a linear distortion curve.

### FIELD OF THE INVENTION

The invention relates to optical projection and in particular to an optical projection apparatus reducing projection distortion.

### DESCRIPTION OF THE RELATED ART

A ratio of projection distance is a critical factor in image projection by an optical projection apparatus. Aforementioned ratio means the ratio of the length of a diagonal line of a projection display component to the distance from projection lens to the projection display component. Using FIGS. 1a and 1b as an example, an optical projection apparatus comprises a projection display component (such as a screen 10) and a projection lens 14. Here, the ratio of projection distance is the ratio of length of a diagonal line 12 of projection display component 10 to distance 16 from projection lens 14 to the projection display component 10. Generally, distance 16 of a conventional optical projection apparatus is longer. Referring to FIGS. 1a and 1b, a ratio of length of diagonal line 12 (FIG. 1a) to distance 16 (FIG. 1b) is (3:1). Projection lens 14 is set according to the ratio. For specific optical projection apparatus, such as a rear-projection TV (RPTV) or a rear-projection projector, the projection distance may be shorter (as shown in distance 18 of FIG. 1b). In this case, the ratio of projection distance is the ratio of length of diagonal line 12 (FIG. 1a) to distance 20 (FIG. 1b), which can be (6:1) or (10:1). If the projection lens set for the general ratio of projection distance, for example, (3:1), is used in this case, serious distortion may occur.

Distortion of projection image may deteriorate image quality. Distortion of projection image can be positive distortion or negative distortion. Referring to FIGS. 2a and 2b. Using FIG. 2a as an example of positive distortion, wherein a distorted actual projection image 104 is larger than an ideal projection image 100 free from distortion. Additionally, the largest visible projection image 102 is shown in FIG. 2a. Using FIG. 2b as an example of negative distortion, wherein a distorted actual projection image 204 is smaller than an ideal projection image 200 free from distortion. Additionally, the largest visible projection image 202 is shown in FIG. 2b. As shown in FIGS. 2a and 2b, area marked with slant lines cannot be utilized, thus causing waste.

Conventionally, the maximum absolute distortion rate is lowered to ameliorate the described image distortion. Referring to distortion curves shown in FIGS. 6a and 6b, the distortion curve specifies relationships between distortion rates and projection optical fields of projection lens. The optical field specifies a normalized height of an image of an object. Here, a center of an undistorted ideal projection image is regarded as a norm, and an optical field of the center thereof is set to 0. Within the ideal projection image, the point farthest from the center is assigned an optical field 1, and optical fields corresponding to other parts of the ideal projection image range between 0 and 1. The distortion rate is a distance ratio of an actual projection image to an ideal projection image in a certain optical field. According to a conventional method, distortion rates corresponding to the maximum optical field and other optical fields are reduced. For example, one may try to adjust the distortion curve D to be the distortion curve D′. Generally, a trade-off effect may occur between distortion rate and other optical characteristics of an optical lens. For example, to reduce the absolute distortion rate may deteriorate focusing, aberration or other optical characteristics. The conventional method, therefore, may improve image distortion at the expense of other optical characteristics.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A projection lens is provided. The projection lens comprises at least one lens. The projection lens conforms to a specific distortion curve. The distortion curve specifies relationships between distortion rates and projection optical fields of the projection lens. A first distortion rate difference within a projection optical field range on the distortion curve is less than a second distortion rate difference within the same projection optical field range on a linear distortion curve.

Also provided is an optical projection apparatus. The optical projection apparatus comprises a light source, a light controlling module, and a projection lens. The projection lens comprises at least one lens, wherein the projection lens conforms to a specific distortion curve. The distortion curve specifies corresponding relationships between distortion rates and projection optical fields of the projection lens. A first distortion rate difference within a projection optical field range on the distortion curve is less than a second distortion rate difference within the projection optical field range on a linear distortion curve. A light beam generated from the light source is controlled by the light controlling module, and projected through the projection lens to generate a projection image. The light source is a device for generating a light beam, such as a laser device. The light controlling module is a device for controlling the path that the light goes through, such as a DMD (digital micro-mirror device).

Also provided is an optical projection method for reducing relative distortion rate of an optical projection apparatus. The projection lens conforms to a distortion curve, comprising a projection lens comprising at least one lens. The distortion curve specifies corresponding relationships between distortion rates and projection optical fields of the projection lens. A specific distortion curve is first determined, wherein a first distortion rate difference within a projection optical field range on the distortion curve is less than a second distortion rate difference within the projection optical field range on a linear distortion curve. At least one of the following characteristics of the lens is adjusted to make the projection lens conform to the specific distortion curve: curvature, material, thickness, and space between lenses. The projection lens conforming to the specific distortion curve in the optical projection apparatus is provided to generate an actual projection image. A polygonal area is selected from the actual projection image as a visible projection image of the projection lens.

### DESCRIPTION OF THE DRAWINGS

The file of this patent contains at least one drawing executed in color. Copies of this patent with color drawing(s) will be provided by the Office upon request and payment of the necessary fee.

The invention can be more fully understood by reading the subsequent detailed description and examples with references made to the accompanying drawings, wherein:

(Related Art) FIGS. 1a and 1b are schematic views of a ratio of projection distance;

(Related Art) FIG. 2a illustrates positive distortion;

(Related Art) FIG. 2b illustrates negative distortion;

FIG. 3 shows an embodiment of an optical projection apparatus;

FIGS. 4a˜4c show distortion curves of projection lens;

FIG. 5 is a flowchart of an embodiment of an optical projection method;

(Related Art) FIGS. 6a and 6b show distortion curves;

FIG. 7 shows an embodiment of an area excluded from a visible projection image because of image distortion; and

FIGS. 8a˜10c illustrate an embodiment of adjusting projection lens.

### DETAILED DESCRIPTION

One or more specific embodiments of the invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constrains, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

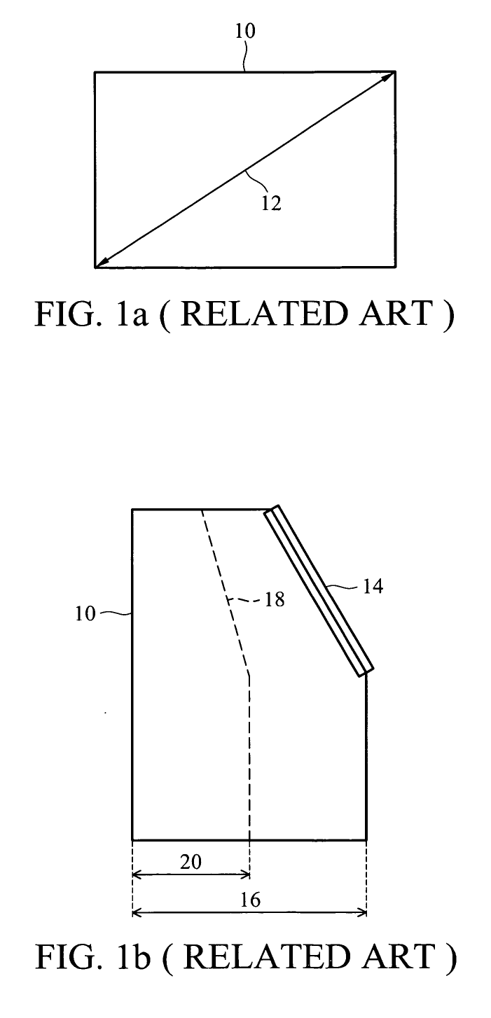

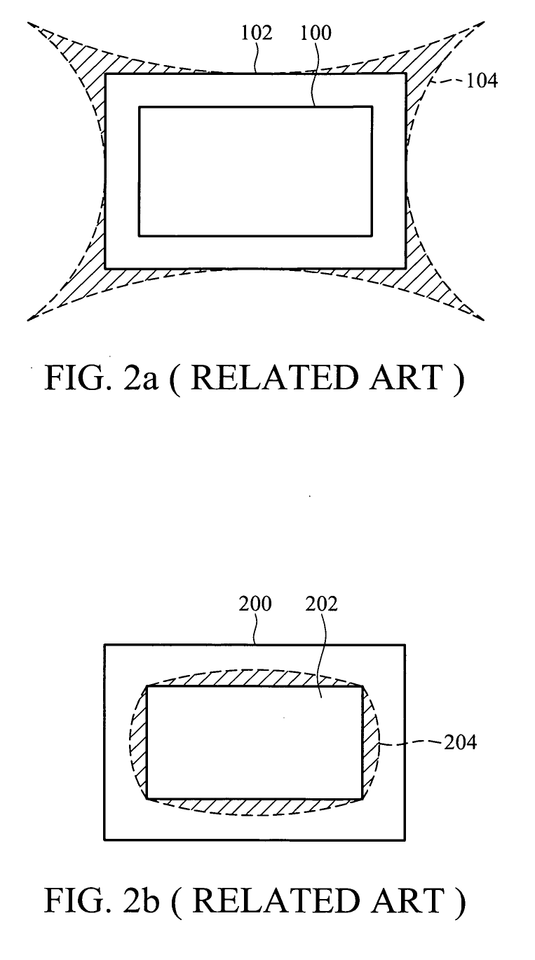

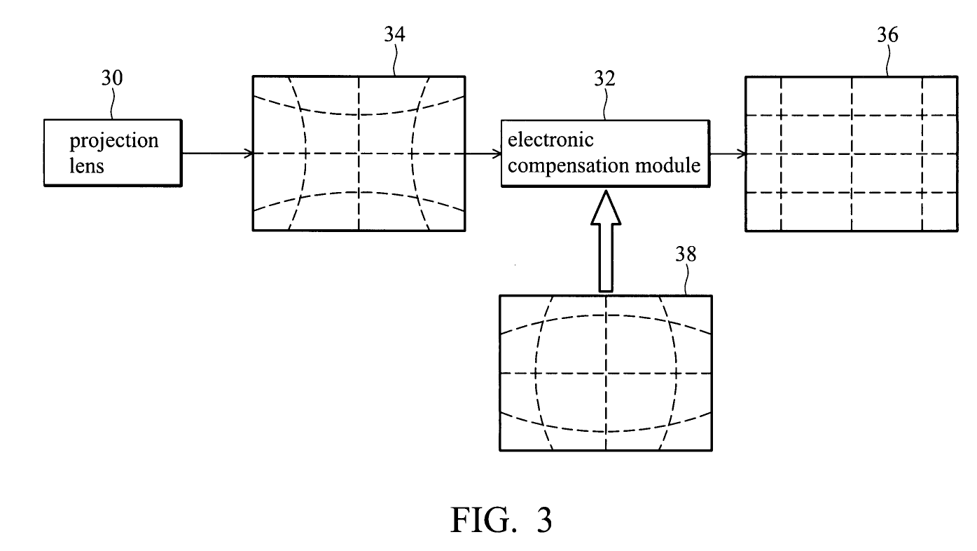

FIG. 3 shows an embodiment of an optical projection apparatus. As shown, an optical projection apparatus is provided, comprising a projection lens 30 and an electronic compensation module 32. The projection lens 30 comprises at least one lens. The lens can be a non-spherical lens. The projection lens 30 conforms to a specific distortion curve. The distortion curve specifies corresponding relationships between distortion rates and projection optical fields of the projection lens, wherein a first distortion rate difference within a projection optical field range on the distortion curve is less than a second distortion rate difference within the same projection optical field range on a linear distortion curve. Here, at least one of the following characteristics of the projection lens 30 is adjusted to make the projection lens conform to a specific distortion curve: curvature, material, thickness, and space between lenses. A polygonal area is then selected from an actual projection image generated from the projection lens 30. The selected polygonal area is regarded as a visible projection image 34 of the projection lens 30. If the visible projection image 34 still suffers from distortion, the visible projection image 34 can be further modified by electronic compensation module 32. The electronic compensation module 32 is set to modify visible projection image 34 of projection lens 30 to be an undistorted or less-distorted projection image 36.

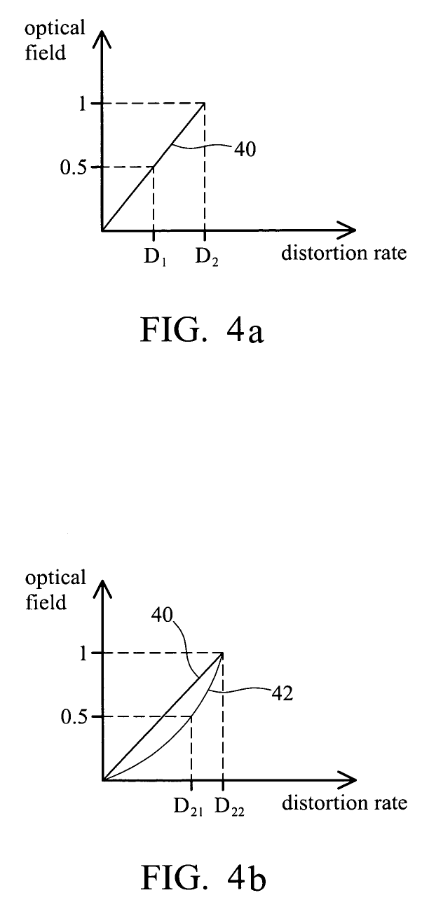

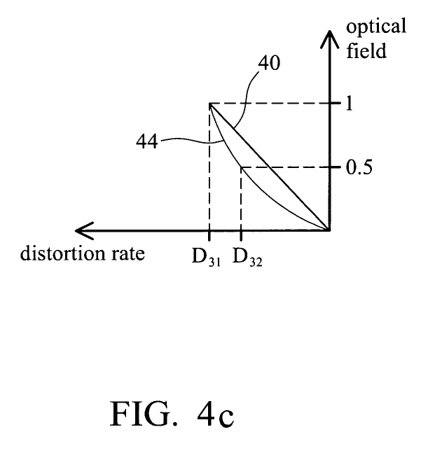

Referring to FIGS. 4a˜4c, distortion curves of projection lenses are illustrated. FIG. 4a illustrates a distortion curve of a conventional projection lens. For example, distortion curve 40 is simplified as a strait line. An optical field range between 1 and 0.5 is selected. A second distortion rate difference within the selected optical field range is (D₂−D₁). FIGS. 4b and 4c illustrate distortion curves of embodiments of a projection lens of the invention. FIG. 4b illustrates a distortion curve specifying positive distortion, and FIG. 4c illustrates a distortion curve specifying negative distortion. According to an embodiment, an optical projection method for reducing relative distortion rate of an optical projection apparatus is provided. The distortion rate corresponding to the maximum optical field, i.e. 1, remains the same, while differences between distortion rate of other optical field values and the distortion rate of the maximum optical field are reduced. For example, an optical field range between 1 and 0.5 is selected on distortion curve 42. According to distortion curve 42, a first distortion rate difference within the selected optical field range is (D₂₂−D₁₁), wherein (D₂₂−D₁₁)<(D₂−D₁). Similarly, using FIG. 4c as an example, an optical field range between 1 and 0.5 is selected on distortion curve 44. According to distortion curve 44, a first distortion rate difference within the selected field optical range is (D₃₂−D₃₁), wherein (D₃₂−D₃₁)<(D₂−D₁).

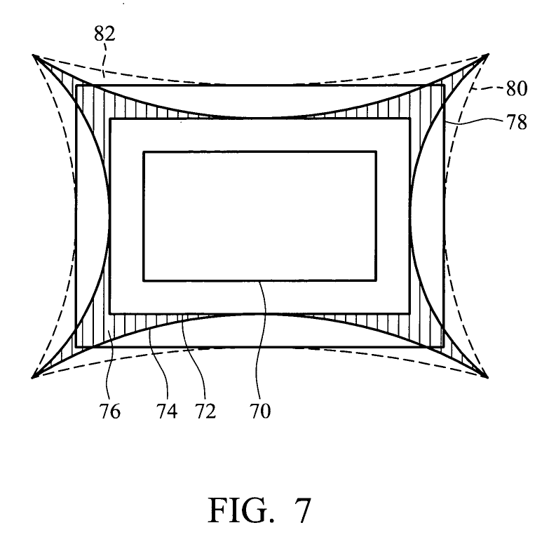

According to the disclosed optical projection method for reducing relative distortion rate, area excluded from a visible projection image due to image distortion can be reduced. FIG. 7 illustrates an embodiment of an area excluded from a visible projection image due to positive image distortion. An ideal projection image 70, a first actual projection image 74, and a first maximum visible projection image 72 are illustrated. The first actual projection image 74 and the first maximum visible projection image 72 are generated using a conventional projection method. Additionally, a second actual projection image 80 and a second maximum visible projection image 78 are illustrated, wherein the second actual projection image 80 and second maximum visible projection image 78 are generated using an embodiment of the projection method provided by the invention. According to the first actual projection image 74 and first maximum visible projection image 72, the area excluded from the visible projection image is the first area 76, marked by straight lines. According to the second actual projection image 80 and second maximum visible projection image 78, the area excluded from the visible projection image is the second area 82. As shown in FIG. 7, second area 82 is smaller than first area 76. In other words, the area excluded from the visible projection image is smaller using the method provided in the invention. In addition, the disclosed method improves image distortion without seriously deteriorating other optical characteristics.

Referring to FIG. 3, after an actual projection image is obtained from projection lens 30, a polygonal area is selected from the actual projection image. The selected polygonal area is regarded as visible projection 34 of the projection lens 30. If the visible projection image 34 still suffers from distortion, the visible projection image 34 can be further modified by electronic compensation module 32. For example, the electronic compensation module 32 is set according to a modification setting 38. The visible projection image 34 of projection lens 30 is then modified to be an undistorted or less-distorted projection image 36. The electronic compensation module 32 can be implemented using known techniques.

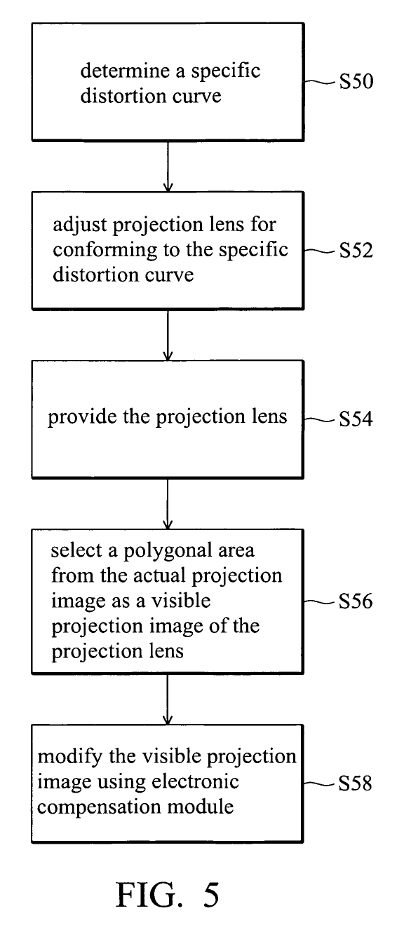

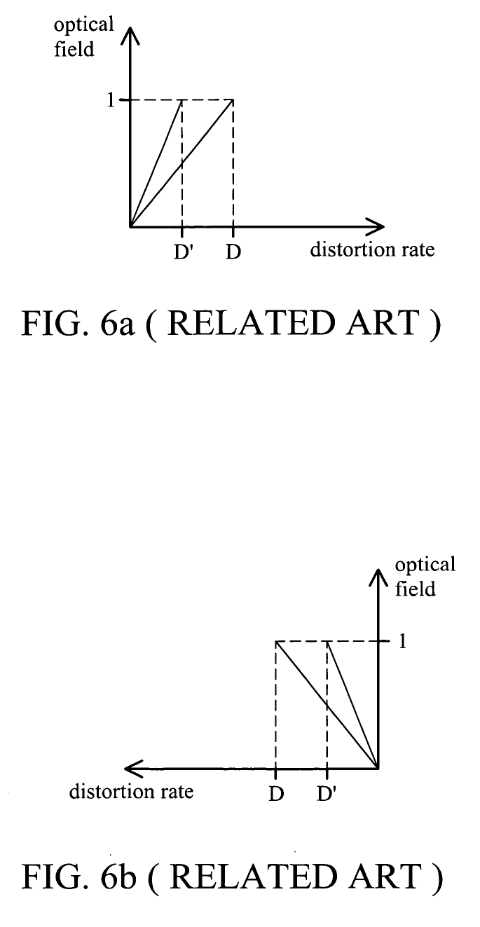

Also provided is an optical projection method for reducing relative distortion rate of an optical projection apparatus. FIG. 5 illustrates a flowchart of an embodiment of an optical projection method. The optical projection apparatus comprises a projection lens comprising at least one lens. The distortion curve specifies corresponding relationships between distortion rates and projection optical fields of the projection lens. A specific distortion curve is first determined (step S50), wherein a first distortion rate difference within a projection optical field range on the distortion curve is less than a second distortion rate difference within the same projection optical field range on a linear distortion curve. At least one of the following characteristics of the lens is adjusted to make the projection lens conforming to the specific distortion curve: curvature, material, thickness, and space between lenses. The at least one lens may be a non-spherical lens. (step S52). The projection lens conforming to the specific distortion curve in the optical projection apparatus is provided to generate an actual projection image (step S54). A polygonal area is selected from the actual projection image as a visible projection image of the projection lens (step S56). The polygonal area can be a largest rectangle within the actual projection image. If the visible projection image still suffers from distortion, the visible projection image can be further modified by electronic compensation module (step S58). The electronic compensation module is set to modify visible projection image of projection lens to generate an undistorted or less distorted projection image. The lens can be a non-spherical lens.

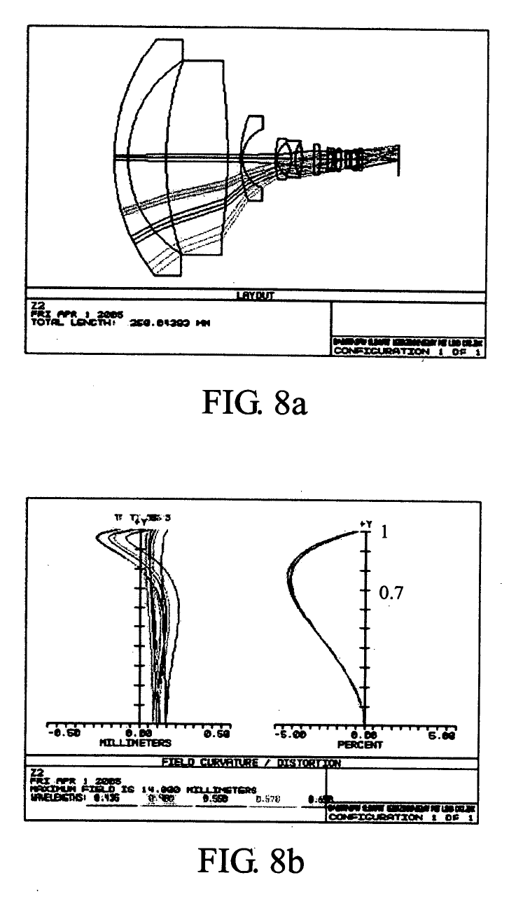

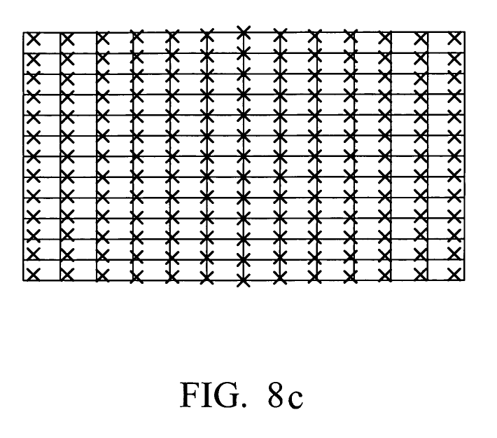

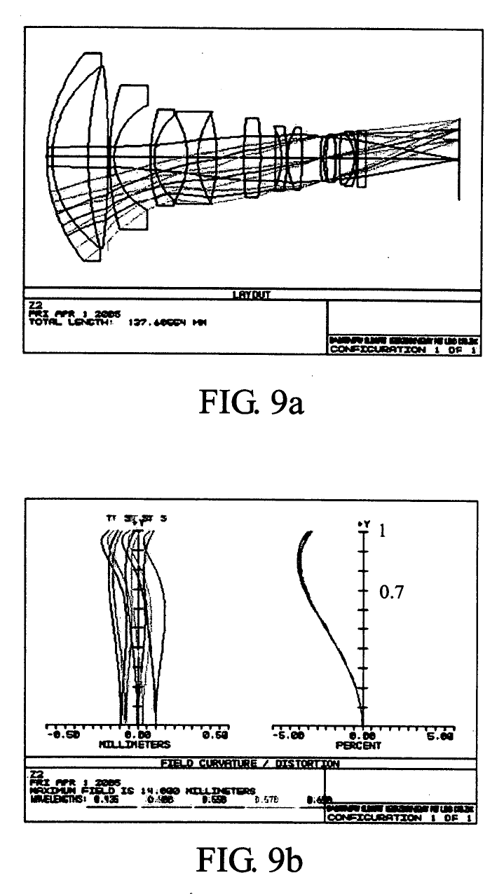

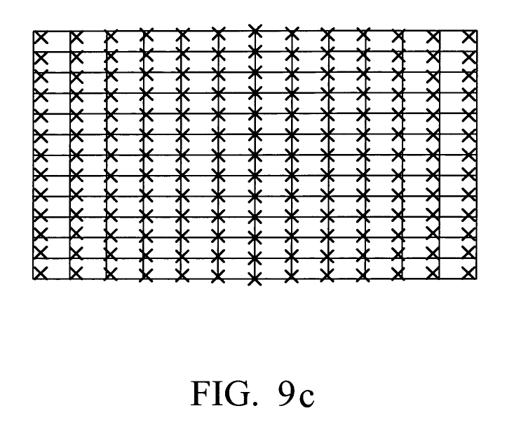

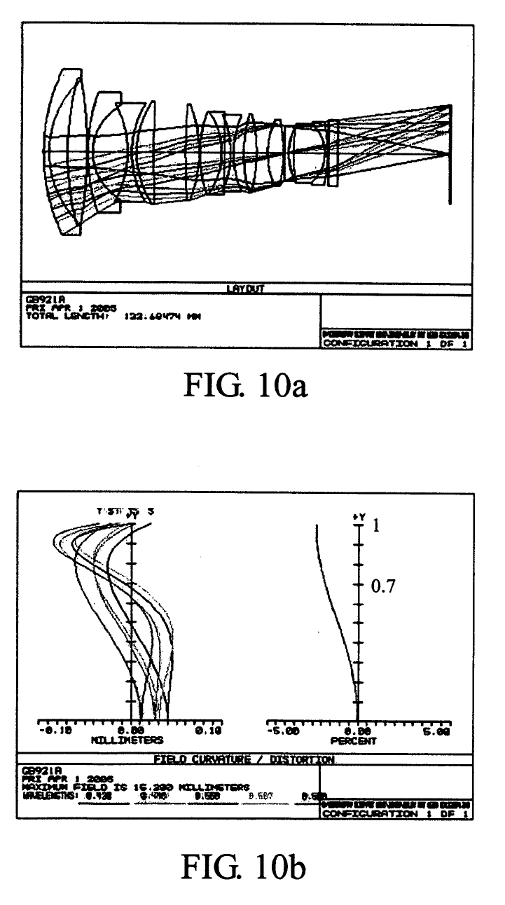

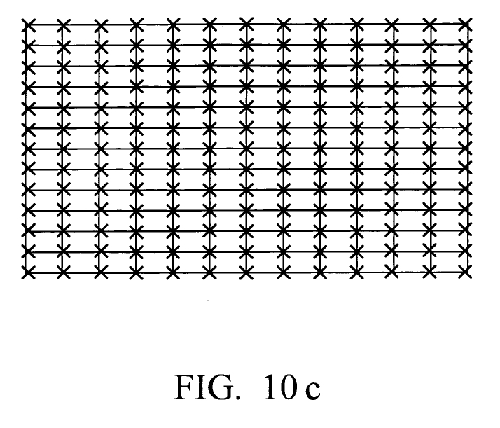

According to an embodiment, optical design software, such as ZEMAX, can be used to adjust the projection lens. Using FIGS. 8a and 8b as an example, an optical field range between 1 and 0.7 is selected in an initial parameter setting. The selected optical field range can be a range near the maximum optical field, in which the projection image distortion is more obvious and easily observed. Using FIG. 8c as an example, the relative distortion rate is about 5%, and projection image distortion is obvious.

Using FIGS. 9a and 9b as an example, parameters are adjusted, such as curvature, materials, thickness of lens, and space between lenses when the number of lenses is more than two. For the same optical field range, the relative distortion rate is reduced to be around 1%, and projection image distortion is improved (as shown in FIG. 9c). Using FIGS. 10a and 10b as an example, the parameters are adjusted again. For the same optical field range, the relative distortion rate is again reduced to be around 0.5%, and projection image distortion is further improved (as shown in FIG. 10c).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A projection lens, comprising at least one lens, wherein the projection lens conforms to a specific distortion curve, the distortion curve specifies relationships between distortion rates and projection optical fields of the projection lens, and a first distortion rate difference within a projection optical field range on the distortion curve is less than a second distortion rate difference within the projection optical field range on a linear distortion curve.

2. The projection lens of claim 1, wherein the lens is non-spherical.

3. The projection lens of claim 1, wherein at least one of curvature, material, thickness, and space between lenses is adjusted to make the projection lens conform to the specific distortion curve.

4. An optical projection apparatus, comprising:
a light source;
a light controlling module; and
a projection lens, comprising at least one lens, wherein the projection lens conforms to a specific distortion curve, the distortion curve specifies corresponding relationships between distortion rate and projection optical field of the projection lens, and a first distortion rate difference within a projection optical field range on the distortion curve is less than a second distortion rate difference within the projection optical field range on a linear distortion curve;
wherein a light beam generated from the light source is controlled by the light controlling module, and projected through the projection lens to generate a projection image.

5. The optical projection apparatus of claim 4, wherein the lens is non-spherical.

6. The optical projection apparatus of claim 4, wherein the projection image is a visible projection image, and the visible projection image is a polygonal area selected from an actual projection image generated from the projection lens.

7. The optical projection apparatus of claim 6, wherein the polygonal area is the largest rectangle within the actual projection image.

8. The optical projection apparatus of claim 4, further comprising an electronic compensation module calibrating the projection image.

9. The optical projection apparatus of claim 8, wherein the electronic compensation module is set according to the projection image, and the projection image is calibrated by the electronic compensation module.

10. The optical projection apparatus of claim 4, wherein at least one of curvature, material, thickness, and space between lenses is adjusted to make the projection lens conform to the specific distortion curve.

11. An optical projection method for reducing relative distortion rate of a distortion curve of an optical projection apparatus, wherein the optical projection apparatus comprises a projection lens comprising at least one lens, the distortion curve specifies corresponding relationships between distortion rates and projection optical fields of the projection lens, the method comprising:
determining a specific distortion curve, wherein a first distortion rate difference within a projection optical field range on the distortion curve is less than a second distortion rate difference within the projection optical field range on a linear distortion curve;
adjusting at least one of curvature, material, thickness, and space between lenses to make the projection lens conform to the specific distortion curve;
providing the projection lens conforming to the specific distortion curve in the optical projection apparatus to generate an actual projection image; and
selecting a polygonal area from the actual projection image as a visible projection image of the projection lens.

12. The optical projection method of claim 11, wherein the lens is non-spherical.

13. The optical projection method of claim 11, wherein the polygonal area is the largest rectangle within the actual projection image.

14. The optical projection method of claim 11, further comprising calibrating the visible projection image using an electronic compensation module.

15. The optical projection method of claim 14, wherein the electronic compensation module is set according to the projection image, and the projection image is calibrated by the electronic compensation module.
